(19) United States
(12) Patent Application Publication
(10) Pub. No.: US 2013/0301297 A1
(43) Pub. Date: Nov. 14, 2013

(54) Backlight Module

(71) Applicants: Yuchun Hsiao, Shenzhen (CN); Yanxue Zhang, Shenzhen (CN)

(72) Inventors: Yuchun Hsiao, Shenzhen (CN); Yanxue Zhang, Shenzhen (CN)

(73) Assignee: Shenzhen China Star Optoelectronics Technology Co, Ltd., Shenzhen City, Guangdong (CN)

(21) Appl. No.: 13/517,978

(22) PCT Filed: May 18, 2012
(86) PCT No.: PCT/CN12/75697

§ 371 Date: Jun. 20, 2012

(30) Foreign Application Priority Data
May 9, 2012 (CN) 201210142079.2

(51) Int. Cl. F21V 8/00; F21V 29/00

(52) U.S. Cl. 362/612; 362/611

(57) ABSTRACT

The present invention provides a backlight module, which includes a backplane, a light guide plate arranged inside the backplane, a backlight source arranged inside the backplane, and a support member arranged inside the backplane to support the light guide plate and the backlight source. The backlight module of the present invention uses a support member to simultaneously support a backlight source and a light guide plate in order to realize sound relative positioning between the backlight source and the light guide plate and improve stability of light coupling. The structure is simple and the cost is low so as to be helpful to realize thinning.

### BACKGROUND OF THE INVENTION

1. Field of the Invention

The present invention relates to the field of liquid crystal displaying, and in particular to a backlight module.

2. The Related Arts

Liquid crystal display (LCD) has a variety of advantages, such as thin device body, low power consumption, and being free of radiation, and is thus widely used. Most of the LCDs that are currently available in the market are backlighting LCDs, which comprise a liquid crystal panel and a backlight module. The working principle of the liquid crystal panel is that liquid crystal molecules are interposed between two parallel glass substrates and a plurality of vertical and horizontal fine electrical wires is arranged between the two glass substrates, whereby the liquid crystal molecules are controlled to change direction by application of electricity in order to refract light emitting from the backlight module for generating images. Since the liquid crystal panel itself does not emit light, light must be provided by the backlight module in order to normally display images. Thus, the backlight module is one of the key components of an LCD. The backlight module can be classified as two types, namely side-edge backlight module and direct backlight module, according to the position where light gets incident. The direct backlight module arranges a light source, such as a cold cathode fluorescent lamp (CCFL) or a light-emitting diode (LED) at the back side of the liquid crystal panel to form a planar light source that directly provides lighting to the liquid crystal panel. The side-edge backlight module arranges an LED light bar based light source at an edge of a back panel to be located rearward of one side of the liquid crystal panel. The LED light bar emits light that enters a light guide plate through a light incident face of the light guide plate and is projected out through a light exit face after being reflected and diffused to thereby form, after transmitting through a set of optic films, a planar light source for the liquid crystal panel.

Referring to FIG. 1, a backlight module generally comprises a backplane 100, a reflector plate 200 arranged inside the backplane 100, a light guide plate 300 disposed on the reflector plate 200, and a backlight source 400 arranged inside the backplane 100. The backlight source 400 is tightly attached to a heat dissipation bar 500 by thermal grease (not shown) or bolts (not shown), whereby heat generated by the backlight source 400 is conducted away by the heat dissipation bar 500 and transmitted to the backplane 100. The backplane 100 comprises a bottom board 102 that dissipates the heat through heat exchange with surrounding air. The heat dissipation bar 500 is generally an aluminum-extruded heat dissipation bar. However, the aluminum-extruded heat dissipation bar is of a high cost and thus an aluminum sheet based heat dissipation plate is gradually taking the place of the aluminum-extruded heat dissipation bar. Alternatively, the backlight module 400 is directly attached to the backplane 100 for direct dissipation of heat.

Getting thinned is the trend of development of today's liquid crystal display devices and the thickness of the light guide plate 30 must be thus reduced. Reducing the thickness of the light guide plate 300 may lead to deteriorating strength of the light guide plate 300. Additional structures may thus be needed to support the light guide plate 300 at such a level corresponding to the backlight source 400 in order to maintain conditions of light incidence.

Referring to FIG. 2, a schematic view showing the structure of a backlight module for thin liquid crystal display device is illustrated. The backlight module comprises a backplane 100′, a reflector plate 200′ arranged inside the backplane 100′, a light guide plate 300′ disposed on the reflector plate 200′, a backlight source 400′ arranged inside the backplane 100′, and an aluminum-sheet based heat dissipation plate 500′. The aluminum-sheet based heat dissipation plate 500′ forms a raised rib 502′ thereon for supporting the light guide plate 300′ in order to realize the light guide plate 300′ being set at the same level as the backlight source 400′.

However, the formation of the raised rib 502′ causes a constraint that sets a distance for the light coupling position. Further, the thickness-reduced light guide plate 300′ often deflects at the light incident end due to insufficiency of strength (as shown in FIG. 3), resulting in error of light coupling and thus a great amount of light emitting from the backlight source leaking outward. This deteriorates light coupling efficiency and also easily forms bright line areas close to the light incident face of the light guide plate 300′.

### SUMMARY OF THE INVENTION

Thus, an object of the present invention is to provide a backlight module, which has a simple structure and low cost and is helpful for thinning.

To achieve the object, the present invention provides a backlight module, which comprises a backplane, a light guide plate arranged inside the backplane, a backlight source arranged inside the backplane, and a support member arranged inside the backplane to support the light guide plate and the backlight source.

The support member is arranged in a stepwise configuration.

The support member comprises a first supporting section that supports the backlight source and a second supporting section that is connected to the first supporting section and supports the light guide plate.

The first supporting section and the second supporting section are integrally formed together.

The first supporting section and the second supporting section are connected together by adhesives or bolting.

The support member is made of silicone rubber, plastics, or metal and the backlight source comprises a linear LED light source.

The backplane comprises a bottom plate and a side plate connected to an edge of the bottom plate. The bottom plate and the side plate define a receiving space, in which the light guide plate, the backlight source, and the support member are received and retained.

The backlight module further comprises a heat dissipation plate that is positioned on the bottom plate of the backplane and a reflector plate that is arranged at one side of the light guide plate that is close to the bottom plate. The heat dissipation plate comprises a vertical section and a horizontal section connected to the vertical section. The backlight source is mounted to the vertical section of the heat dissipation plate. The support member is mounted to the horizontal section of the heat dissipation plate. The second supporting section supports the reflector plate.

The heat dissipation plate is made of an aluminum sheet; and

The horizontal section of the heat dissipation plate forms thereon a plurality of raised ribs and the reflector plate is supported on the raised ribs.

The efficacy of the present invention is that the present invention provides a backlight module that comprises a support member to simultaneously support a backlight source and a light guide plate in order to realize sound relative positioning between the backlight source and the light guide plate and improve stability of light coupling and that has a simple structure and low cost and is helpful to realize thinning.

For better understanding of the features and technical contents of the present invention, reference will be made to the following detailed description of the present invention and the attached drawings. However, the drawings are provided for the purposes of reference and illustration and are not intended to impose undue limitations to the present invention.

### BRIEF DESCRIPTION OF THE DRAWINGS

The technical solution, as well as beneficial advantages, will be apparent from the following detailed description of an embodiment of the present invention, with reference to the attached drawings. In the drawings:

FIG. 1 is a schematic view showing the a conventional backlight module;

FIG. 2 is a schematic view showing a backlight module of thin liquid crystal display device;

FIG. 3 is a schematic view illustrating deformation of light guide plate and reflector plate shown in FIG. 2;

FIG. 4 is a schematic view showing a backlight module according to the present invention;

FIG. 5 is a perspective view showing the backlight module according to another embodiment of the present invention; and

FIG. 6 is a schematic view showing a backlight module according to another embodiment of the present invention.

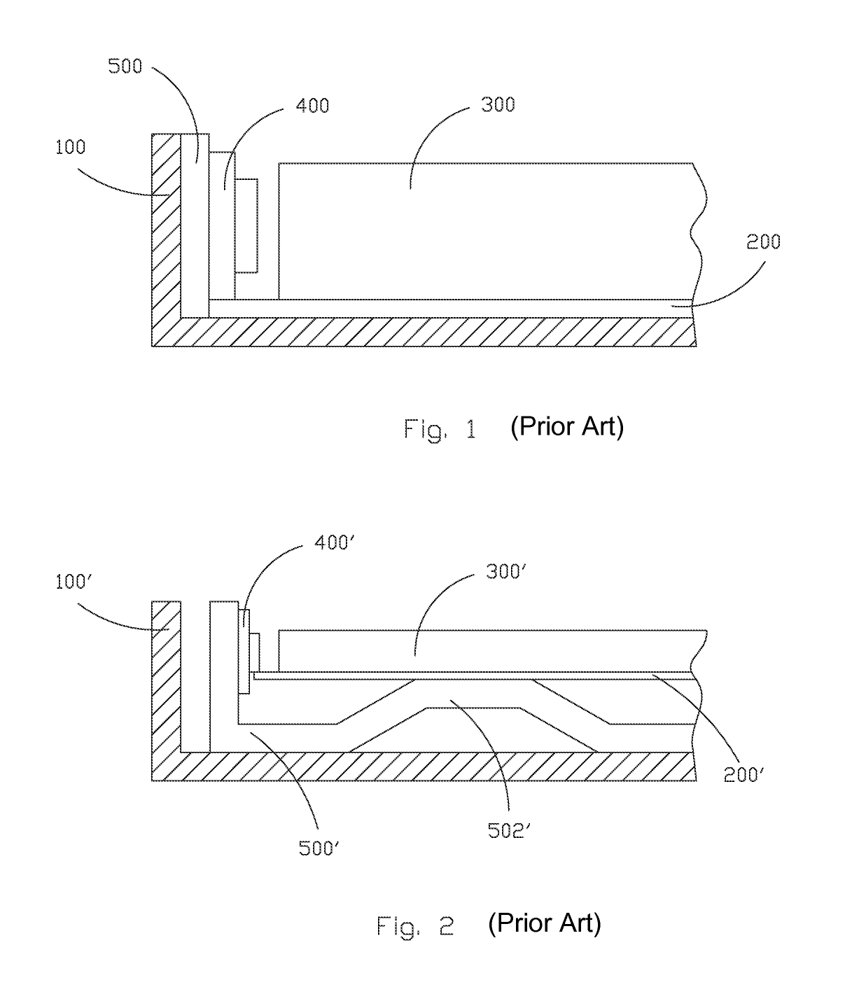

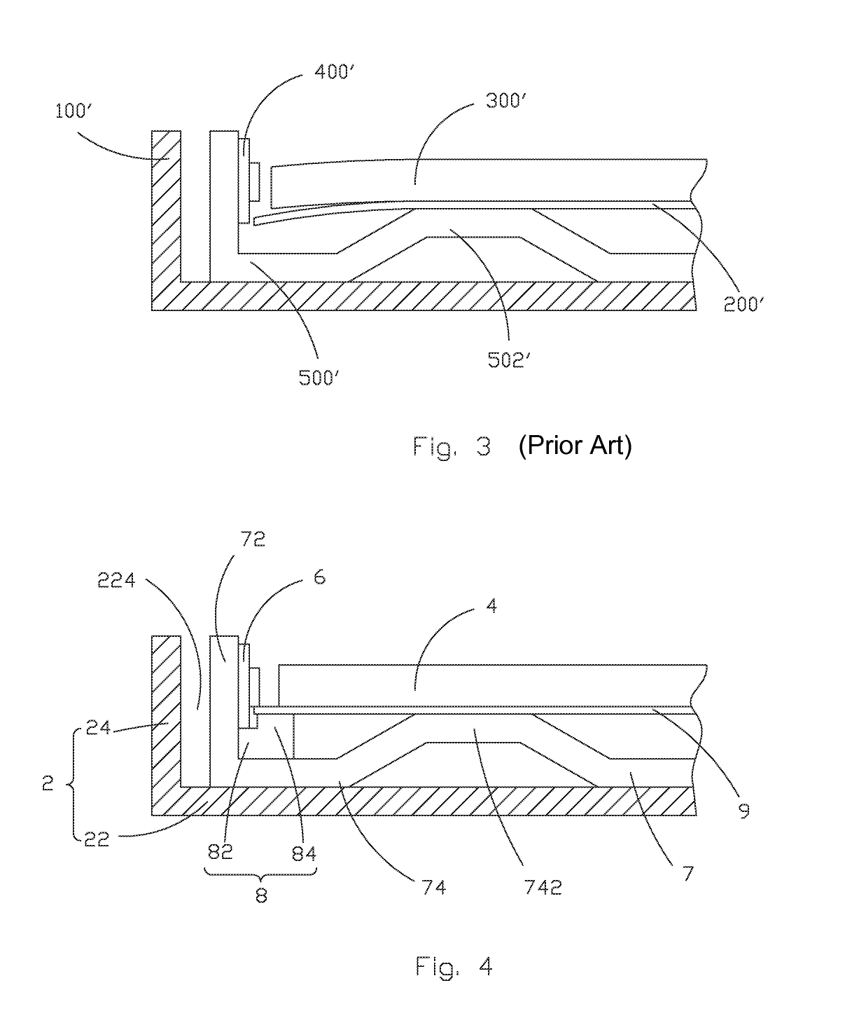

### DETAILED DESCRIPTION OF THE PREFERRED EMBODIMENTS

To further expound the technical solution adopted in the present invention and the advantages thereof, a detailed description is given to a preferred embodiment of the present invention and the attached drawings.

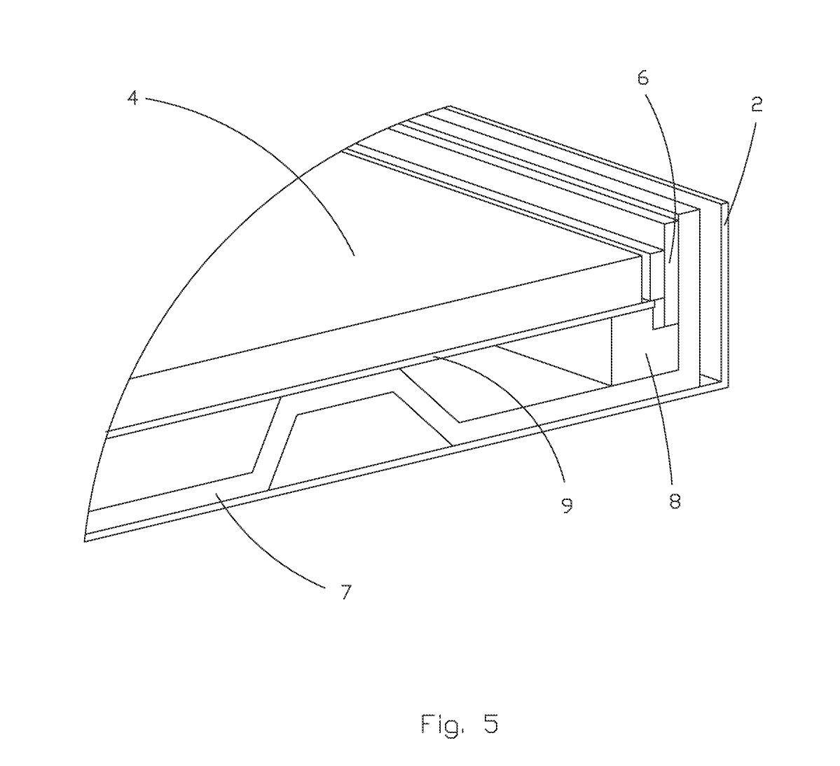

Referring to FIGS. 4 and 5, the present invention provides a backlight module, which comprises: a backplane 2, a light guide plate 4 arranged inside the backplane 2, a backlight source 6 arranged inside the backplane, and a support member 8 arranged inside the backplane 2 to support the light guide plate 4 and the backlight source 6. The support member 8 supports the light guide plate 4 and the backlight source 6, so as to ensure sound relative positioning between the light guide plate 4 and the backlight source 6 thereby improving stability of light coupling.

The support member 8 is arranged in a stepwise configuration, which comprises a first supporting section 82 that supports the backlight source 6 and a second supporting section 84 that is connected to the first supporting section 82 and supports the light guide plate 4.

Preferably, the first and second supporting sections 82, 84 of the support member 8 are integrally formed together and made of silicone rubber, plastics, or metal.

The backplane 2 comprises a bottom plate 22 and a side plate 24 connected to an edge of the bottom plate 22. The bottom plate 22 and the side plate 24 define a receiving space 224, and the light guide plate 4, the backlight source 6, and the support member 8 are all received and retained in the receiving space 224.

The backlight module further comprise a heat dissipation plate 7 that is positioned on the bottom plate 22 of the backplane 2 and a reflector plate 9 that is arranged at one side of the light guide plate 4 that is close to the bottom plate 22. The heat dissipation plate 7 comprises a vertical section 72 and a horizontal section 74 connected to the vertical section 72. The backlight source 6 is mounted to the vertical section 72 of the heat dissipation plate 7 to enhance the effect of heat dissipation. In the instant embodiment, the heat dissipation plate 7 is made of an aluminum sheet that is inexpensive in cost so that the manufacture cost can be reduced. The support member 8 is mounted to the horizontal section 74 of the heat dissipation plate 7 and the second supporting section 84 supports the reflector plate 9 and thus indirectly supports the light guide plate 4.

The backlight source 6 comprises a linear LED (Light-Emitting Diode) light source, which emits light that directly enters or is reflected by the reflector plate 9 into the light guide plate 4 to provide a homogenous planar light source.

It is noted that the horizontal section 74 of the heat dissipation plate 7 forms thereon a plurality of raised ribs 742 and the reflector plate 9 is supported on the raised ribs 742 to thereby effect supporting and positioning of the light guide plate 4.

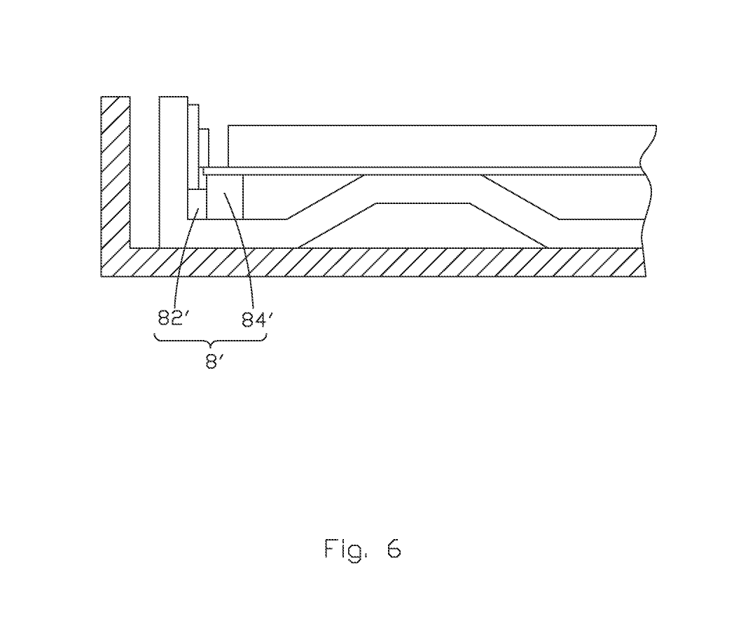

Referring to FIG. 6, a schematic view showing a backlight module according to another embodiment of the present invention is given. In the instant embodiment, a support member 8′ comprises a first supporting section 82′ and a second supporting section 84′ connected to the first supporting section 82′. The first and second supporting sections 82′, 84′ are connected together by adhesives, bolting, or other measures. The first and second supporting sections 82′, 84′ can be made of the same material or they are made of different materials. Preferably, the first supporting section 82′ is made of a metallic material in order to enhance thermal conductivity of the backlight module and the second supporting section 84′ is made of a plastic material in order to reduce the cost.

The present invention provides a backlight module that comprises a support member to simultaneously support a backlight source and a light guide plate in order to realize sound relative positioning between the backlight source and the light guide plate and improve stability of light coupling and that has a simple structure and low cost and is helpful to realize thinning.

Based on the description given above, those having ordinary skills of the art may easily contemplate various changes and modifications of the technical solution and technical ideas of the present invention and all these changes and modifications are considered within the protection scope of right for the present invention.

What is claimed is:

1. A backlight module, comprising a backplane, a light guide plate arranged inside the backplane, a backlight source arranged inside the backplane, and a support member arranged inside the backplane to support the light guide plate and the backlight source.

2. The backlight module as claimed in claim 1, wherein the support member is arranged in a stepwise configuration.

3. The backlight module as claimed in claim 2, wherein the support member comprises a first supporting section that supports the backlight source and a second supporting section that is connected to the first supporting section and supports the light guide plate.

4. The backlight module as claimed in claim 3, wherein the first supporting section and the second supporting section are integrally formed together.

5. The backlight module as claimed in claim 3, wherein the first supporting section and the second supporting section are connected together by adhesives or bolting.

6. The backlight module as claimed in claim 1, wherein the support member is made of silicone rubber, plastics, or metal and the backlight source comprises a linear LED light source.

7. The backlight module as claimed in claim 1, wherein the backplane comprises a bottom plate and a side plate connected to an edge of the bottom plate, the bottom plate and the side plate defining a receiving space, in which the light guide plate, the backlight source, and the support member are received and retained.

8. The backlight module as claimed in claim 7 further comprising a heat dissipation plate that is positioned on the bottom plate of the backplane and a reflector plate that is arranged at one side of the light guide plate that is close to the bottom plate, the heat dissipation plate comprising a vertical section and a horizontal section connected to the vertical section, the backlight source being mounted to the vertical section of the heat dissipation plate, the support member being mounted to the horizontal section of the heat dissipation plate, the second supporting section supporting the reflector plate.

9. The backlight module as claimed in claim 8, wherein the heat dissipation plate is made of an aluminum sheet.

10. The backlight module as claimed in claim 8, wherein the horizontal section of the heat dissipation plate forms thereon a plurality of raised ribs and the reflector plate is supported on the raised ribs.

11. A backlight module, comprising a backplane, a light guide plate arranged inside the backplane, a backlight source arranged inside the backplane, and a support member arranged inside the backplane to support the light guide plate and the backlight source;
wherein the support member is arranged in a stepwise configuration;
wherein the support member comprises a first supporting section that supports the backlight source and a second supporting section that is connected to the first supporting section and supports the light guide plate;
wherein the first supporting section and the second supporting section are integrally formed together;
wherein the support member is made of silicone rubber, plastics, or metal and the backlight source comprises a linear LED light source;
wherein the backplane comprises a bottom plate and a side plate connected to an edge of the bottom plate, the bottom plate and the side plate defining a receiving space, in which the light guide plate, the backlight source, and the support member are received and retained;
wherein the backlight module further comprises a heat dissipation plate that is positioned on the bottom plate of the backplane and a reflector plate that is arranged at one side of the light guide plate that is close to the bottom plate, the heat dissipation plate comprising a vertical section and a horizontal section connected to the vertical section, the backlight source being mounted to the vertical section of the heat dissipation plate, the support member being mounted to the horizontal section of the heat dissipation plate, the second supporting section supporting the reflector plate;
wherein the heat dissipation plate is made of an aluminum sheet; and
wherein the horizontal section of the heat dissipation plate forms thereon a plurality of raised ribs and the reflector plate is supported on the raised ribs.
